(19) United States
(12) Patent Application Publication
(10) Pub. No.: US 2021/0358442 A1
(43) Pub. Date: Nov. 18, 2021

(54) DRIVING CIRCUIT, DRIVING METHOD, AND DISPLAY PANEL

(71) Applicant: Shenzhen China Star Optoelectronics Semiconductor Display Technology Co., Ltd., Shenzhen (CN)

(72) Inventor: Caixia WANG, Shenzhen (CN)

(73) Assignee: Shenzhen China Star Optoelectronics Semiconductor Display Technology Co., Ltd., Shenzhen (CN)

(21) Appl. No.: 16/627,789

(22) PCT Filed: Dec. 16, 2019
(86) PCT No.: PCT/CN2019/125620

§ 371 Date: Dec. 31, 2019

(30) Foreign Application Priority Data
Sep. 24, 2019 (CN) 201910904964.1

(51) Int. Cl. G09G 3/36

(52) U.S. Cl. CPC G09G 3/3677; G09G 2320/0242; G09G 2310/08; G09G 2300/0408; G09G 2310/06; G09G 2300/0443; G09G 2300/0842

(57) ABSTRACT

The preset disclosure provides a driving circuit, a driving method, and a display panel including the driving circuit. The driving circuit includes a plurality of gate driver on array (GOA) unit circuits. Odd stages of the GOA unit circuits are cascaded with each other and even stages of the GOA unit circuits are cascaded with each other. Signal lines disposed and corresponding to the odd stages of the GOA unit circuits provide odd stage scan control signals, odd stage scan start signals, and odd stage high frequency clock signals. Signal lines disposed and corresponding to the even stages of the GOA unit circuits provide even stage scan control signals, even stage scan start signals, and even stage high frequency clock signals. A common line disposed and corresponding to all of the GOA unit circuits provides a first low frequency clock signal and a second low frequency clock signal.

### FIELD OF INVENTION

The present disclosure relates to the field of display technologies, more particularly to a driving circuit, a driving method and a display panel including the driving circuit.

### BACKGROUND OF INVENTION

Liquid crystal displays (LCDs) are display panel devices that utilize characteristics of liquid crystal materials to display images and have advantages, such as thin thickness, low driving voltage, low power consumption, etc., in comparison with other display devices.

LCDs usually include gate driving circuits, source driving circuits, and pixel arrays. The pixel array has a plurality of pixel circuits. Each pixel circuit is turned on and off according to scanning signals provided by the gate driving circuit, and image screen is displayed according to data signals provided by the source driving circuit. In the gate driving circuit, the gate driving circuit usually has a multi-stage of shifter register, and the scanning signals are output to the pixel array though a first-stage of shifter register to a next-stage of shifter register. The pixel circuits are turned on sequentially to receive the data signals.

Therefore, in manufacturing driving circuits, the gate driving circuits are directly fabricated on the array substrate to replace driving chips provided by external integer circuits (ICs). This technology is called gate driver on array (GOA) which can be directly formed around the panel, thus production processes and costs are reduced, thereby the panels become thinner.

### Technical Problems

Recently, with the continuous, maturity, and rapid development of technologies, large size, high resolution, and curved surfaces have become the targets and features in the LCD panel market. In the meanwhile, consumers have higher requirements for LCD panels. Color deviation is one of problems for designers in recent years. In order to solve the problem of color deviation, a variety of circuit design methods have been proposed in the pixel regions, which can basically solve the problem of color deviation. However, with the consideration of narrow bezels and low cost, gate driver on array (GOA) technology has entered deeply into the current panel markets. How to make GOA technology effectively match the current low-color deviation circuit design in pixel regions has become the key to the problem of color deviation in circuit design.

Therefore, the present disclosure provides a GOA circuit with adjustable output GateN. By utilizing this GOA circuit, problem of color deviation can effectively solve to achieve high quality LCD panels in high quality.

### SUMMARY OF INVENTION

To solve the above-mentioned technical problems, the object of the present disclosure is providing a driving circuit comprises: a plurality of gate driver on array (GOA) unit circuits, wherein odd stages of the GOA unit circuits are cascaded with each other and even stages of the GOA unit circuits are cascaded with each other; signal lines disposed and corresponding to the odd stages of the GOA unit circuits and configured to respectively provide odd stage scan control signals, odd stage scan start signals, and odd stage high frequency clock signals; signal lines disposed and corresponding to the even stages of the GOA unit circuits and configured to respectively provide even stage scan control signals, even stage scan start signals, and even stage high frequency clock signals; and a common line disposed and corresponding to all of the GOA unit circuits and configured to provide a first low frequency clock signal and a second low frequency clock signal.

The object of the present disclosure is achieved by following technical solutions.

In one embodiment of the present disclosure, each stage of the GOA unit circuit comprises a forward-inverse scan control module, a stage voltage-stable module, an output module, a first pull down module, and a pull down holding module.

One embodiment of the present disclosure further includes a pixel circuit comprising a first switch. A control end of the first switch is configured to receive a gate signal outputted from a GOA unit, a first end of the first switch is electrically connected to an electrode of a main pixel, and a second end of the first switch is configured to receive a data line signal.

One embodiment of the present disclosure further comprises a second switch. A control end of the second switch is configured to receive the gate signal outputted from the GOA unit, a first end of the second switch is electrically connected to an electrode of a sub pixel, and a second end of the second switch is configured to receive the data line signal.

One embodiment of the present disclosure further comprises a third switch. A control end of the third switch is configured to receive a gate signal outputted from a next stage of the GOA unit, a first end of the third switch is electrically connected to a storage capacitor, and a second end of the third switch is electrically connected to the electrode of the sub pixel.

The object of the present disclosure can be further achieved by following technical solutions.

The present disclosure provides a driving method of a driving circuit, comprising: providing the driving circuit according to claim 1; wherein each stage of the GOA unit circuit comprises a forward-inverse scan control module, a stage voltage-stable module, an output module, a first pull down module, and a pull down holding module; providing different delay times by controlling starting times of the scan start signals of the GOA unit circuits; providing different wave widths by separately providing an odd high frequency clock signal and an even high frequency clock signal of a multiple high frequency clock signal circuit with different widths; and providing different wave heights by separately providing signals with different heights to the odd high frequency clock signal and the even high frequency clock.

One embodiment of the present disclosure further includes a pixel circuit comprising a first switch. A control end of the first switch is configured to receive a gate signal outputted from a GOA unit, a first end of the first switch is electrically connected to an electrode of a main pixel, and a second end of the first switch is configured to receive a data line signal.

One embodiment of the present disclosure further comprises a second switch. A control end of the second switch is configured to receive the gate signal outputted from the GOA unit, a first end of the second switch is electrically connected to an electrode of a sub pixel, and a second end of the second switch is configured to receive the data line signal.

One embodiment of the present disclosure further comprises a third switch. A control end of the third switch is configured to receive a gate signal outputted from a next stage of the GOA unit, a first end of the third switch is electrically connected to a storage capacitor, and a second end of the third switch is electrically connected to the electrode of the sub pixel.

Another object of the present disclosure is providing a display panel, comprising: a first substrate; and a second substrate disposed opposite to the first substrate. The display panel further comprises a driving circuit comprising: a plurality of gate driver on array (GOA) circuits, wherein odd stages of the GOA unit circuits are cascaded with each other and even stages of the GOA unit circuits are cascaded with each other; signal lines disposed and corresponding to the odd stages of GOA unit circuits and configured to respectively provide odd stage scan control signals, odd stage scan start signals, and odd stage high frequency clock signals; signal lines disposed and corresponding to the even stages of GOA unit circuits and configured to respectively provide even stage scan control signals, even stage scan start signals, and even stage high frequency clock signals; and a common line disposed and corresponding to all of the GOA unit circuits and configured to provide a first low frequency clock signal and a second low frequency clock signal.

The driving circuit provided in the present disclosure can obtain different brightness of the main pixel and the sub-pixel according to requirements without changing the internal circuit structure of the panel. Especially after the panels are produced, the color deviation can be targeted by externally changing signals of the driving circuits according to the color deviation situation. The adjustable range is wide.

### DESCRIPTION OF DRAWINGS

In order to clarify the technical solutions of embodiments of the present disclosure, drawings required to describe the embodiments are briefly illustrated. Obviously, the mentioned embodiments are only parts of the embodiments instead of all of the embodiments. Other embodiments can be obtained by a skilled person in the art without creative effort fall in the protected scope of the present disclosure.

FIG. 1 illustrates a diagram of multi-stage structure of a driving circuit of the embodiment of the present disclosure.

FIG. 2 illustrates a circuit diagram of a pixel circuit of the embodiment of the present disclosure.

FIG. 3 illustrates a modulated waveform output diagram of the driving circuit of the embodiment of the present disclosure.

FIG. 4 illustrates the modulated waveform output diagram of the driving circuit and illustrates a voltage potential diagram of pixels of the embodiment of the present disclosure.

FIG. 5 illustrates a flow chart of a driving method of the driving circuit of the embodiment of the present disclosure.

### DETAILED DESCRIPTION OF PREFERRED EMBODIMENTS

Please refer to drawings, in the drawing, structurally similar elements are denoted by the same reference numbers. The following description is based on the exemplified specific embodiments of the present disclosure, which should not be construed as limiting other specific embodiments that are not detailed herein.

The following description of the various embodiments is provided with reference of drawings to illustrate specific embodiments. Directional terms mentioned in the present disclosure, such as upper, lower, front, back, left, right, inside, outside, lateral, etc., are only referring to the direction of the drawing. Therefore, the directional terms used to describe and clarify the present disclosure should not be viewed as limitations of the present disclosure.

In the drawings, thicknesses of layers, films, panels, regions, etc. are exaggerated for clarity. In the drawings, the thicknesses of some layers and regions are exaggerated for easily understanding the description. It will be understood that when a component such as a layer, film, region, or substrate is referred to as being “on” another component, it can be directly on the other component or intervening components may also be present.

The drawings and description are to be regarded as illustrative instead of restrictive. In the drawings, similarly structured units are denoted by the same reference numerals. In addition, for easily understanding the description, the size and thickness of each component shown in the drawings are arbitrarily, but the present disclosure is not limited thereto.

In addition, in the specification, unless explicitly and exclusively described, the word “comprising” will be understood to mean including the recited component, but not excluding any other components. In addition, in the specification, “on” means located above or below the target component, and does not mean that it must be located on top based on the direction against gravity.

In order to further explain the desired technical solutions and effects by adopting the present disclosure, a driving circuit, a driving method thereof, and a display panel including the driving circuit of the present disclosure are described below accompanying with the drawings and specific embodiments. The specific implementation, structure, characteristics and effects thereof will be described in detail later.

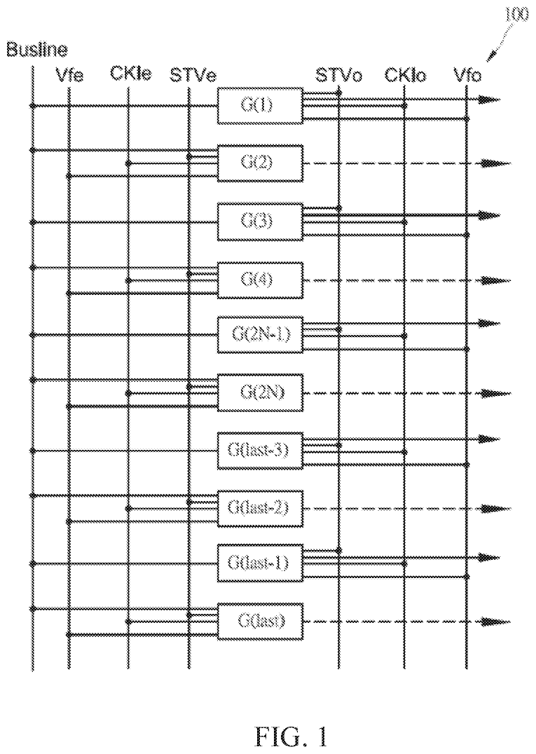

FIG. 1 is a multi-level architecture diagram of a driving circuit according to an embodiment of the present disclosure.

Please refer to FIG. 1, in an embodiment of the present disclosure, a driving circuit 100 includes: a plurality of GOA units, G1, G2 to G (last). Odd stages of the GOA unit circuits are cascaded with each other and even stages of the GOA unit circuits are cascaded with each other. Signal lines are disposed and correspond to the odd stages of the GOA unit circuits and are configured to respectively provide odd stage scan control signals Vfo, odd stage scan start signals STVo, and odd stage high frequency clock signals CKIo. Signal lines are disposed and correspond to the even stages of the GOA unit circuits and are configured to respectively provide even stage scan control signals Vfe, even stage scan start signals STVe, and even stage high frequency clock signal CKIe. Common lines Busline are disposed and correspond to all of the GOA unit circuits and are configured to provide a first low frequency clock signal and a second low frequency clock signal.

In one of embodiments of the present disclosure, each stage of the GOA unit circuit, G1, G2 to G(last)m includes a forward-inverse scan control module (not shown), a stage voltage-stable module (not shown), an output module (not shown), a first pull down module (not shown), and a pull down holding module (not shown).

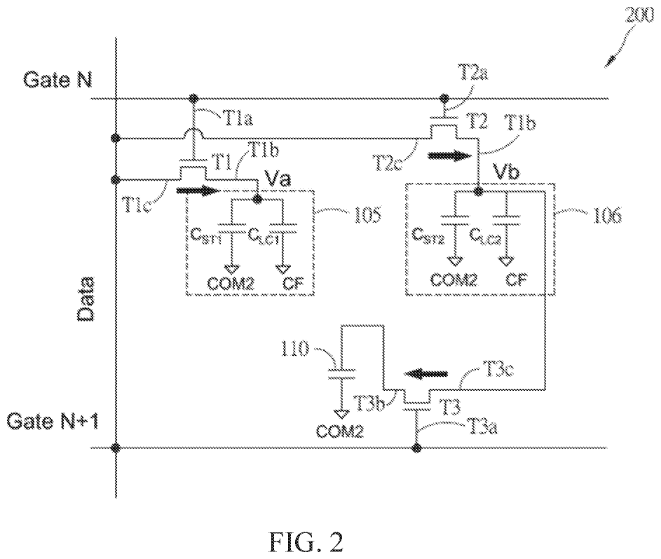

FIG. 2 illustrates a circuit diagram of a pixel circuit of the embodiment of the present disclosure. Please refer to FIG. 2, one of embodiments of the present disclosure further includes a pixel circuit 200 including a first switch T1. A control end T1a of the first switch T1 is configured to receive a gate signal GateN outputted from a GOA unit. A first end T1b of the first switch T1 is electrically connected to an electrode Va of a main pixel 105. A second end T1c of the first switch T1 is configured to receive a data line signal Data for charging the main pixel 105.

Please refer to FIG. 2, one of embodiments of the present disclosure further includes a second switch T2. A control end T2a of the second switch T1 is configured to receive the gate signal GateN outputted from a GOA unit. A first end T2b of the second switch T2 is electrically connected to an electrode Vb a sub pixel 106. A second end T2c of the second switch T2 is configured to receive the data line signal Data for charging the sub pixel electrode 106.

Please refer to FIG. 2, one of embodiments of the present disclosure further includes a third switch T3. A control end T3a of the second switch T3 is configured to receive a gate signal GateN+1 outputted from a next stage of GOA unit. A first end T3b of the second switch T3 is electrically connected to a storage capacitor 110. A second end T3c of the second switch T3 is electrically connected to the electrode Vb of the sub pixel 106.

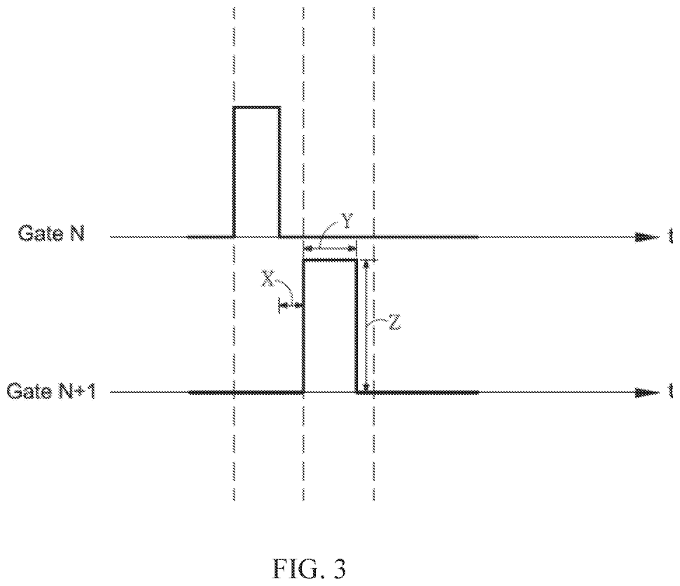

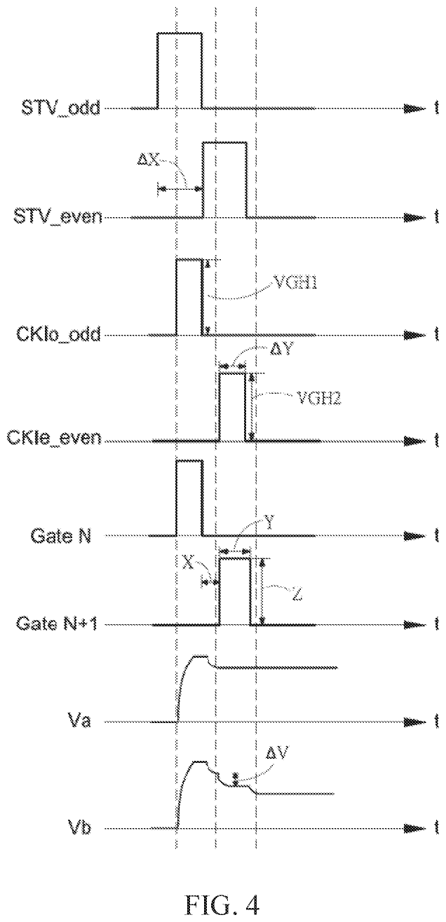

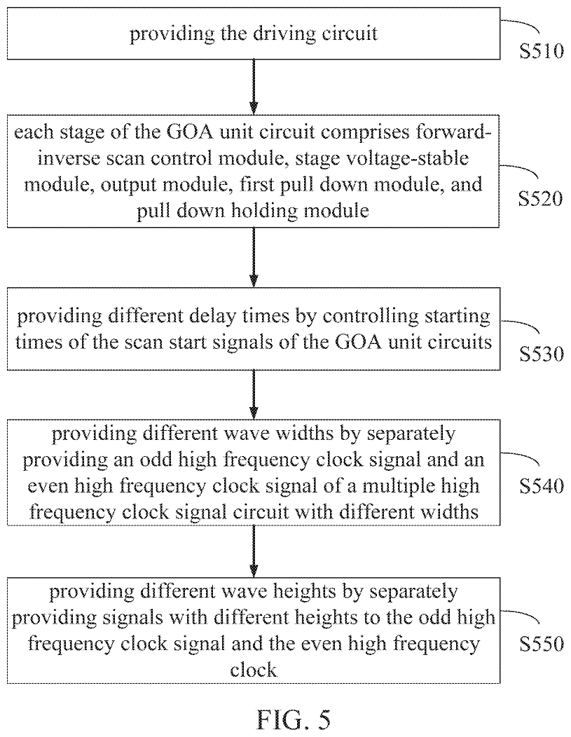

FIG. 3 illustrates a modulated waveform output diagram of the driving circuit of the embodiment of the present disclosure. FIG. 4 illustrates the modulated waveform output diagram of the driving circuit and illustrates a voltage potential diagram of pixels of the embodiment of the present disclosure. FIG. 5 illustrates a flow chart of a driving method of the driving circuit of the embodiment of the present disclosure. Please refer to FIGS. 1, 3, 4, and 5, in one of embodiments of the present disclosure, a driving method of the driving circuit 100 including: providing the driving circuit 100. Each stage of the GOA unit circuit G1, G2 to G(last) includes the forward-inverse scan control module, the stage voltage-stable module, the output module, the first pull down module, and the pull down holding module. Providing different delay times X by controlling starting times ΔX of the scan start signals STV of the GOA unit circuits. Providing different wave widths Y by separately providing an odd high frequency clock signal CKIo_odd and an even high frequency clock signal CKIe_even of a multiple high frequency clock signal CK with different widths ΔY. Providing different wave heights Z by separately providing signals with different heights VGH1, VGH2 to the odd high frequency clock signal CKIo_odd and the even high frequency clock CKIe_even.

Please refer to FIG. 2, the method of one of the embodiment of the present disclosure further includes the pixel circuit 200 including the first switch T1. A control end T1a of the first switch T1 is configured to receive a gate signal GateN outputted from a GOA unit. A first end T1b of the first switch T1 is electrically connected to an electrode Va of a main pixel 105. A second end T1c of the first switch T1 is configured to receive a data line signal Data for charging the main pixel 105.

Please refer to FIG. 2, the method of one of embodiments of the present disclosure further includes a second switch T2. A control end T2a of the second switch T1 is configured to receive the gate signal GateN outputted from a GOA unit. A first end T2b of the second switch T2 is electrically connected to an electrode Vb a sub pixel 106. A second end T2c of the second switch T2 is configured to receive the data line signal Data for charging the sub pixel electrode 106.

Please refer to FIG. 2, the method of one of embodiments of the present disclosure further includes a third switch T3. A control end T3a of the second switch T3 is configured to receive a gate signal GateN+1 outputted from a next stage of GOA unit. A first end T3b of the second switch T3 is electrically connected to a storage capacitor 110. A second end T3c of the second switch T3 is electrically connected to the electrode Vb of the sub pixel 106.

Please refer to FIG. 1, in one of embodiments of the present disclosure, a display panel 10 includes a first substrate and a second substrate disposed opposite to the first substrate, and further includes a the driving circuit 100 including a plurality of the GOA unit circuit G1, G2 to G(last). The odd stages of the GOA unit circuits are cascaded with each other and the even stages of the GOA unit circuits are cascaded with each other. The signal lines are disposed and correspond to the odd stages of the GOA unit circuits and are configured to respectively provide the odd stage scan control signals Vfo, the odd stage scan start signals STVo, and the odd stage high frequency clock signals CKIo. The signal lines are disposed and correspond to the even stages of the GOA unit circuits and are configured to respectively provide the even stage scan control signals Vfe, the even stage scan start signals STVe, and the even stage high frequency clock signal CKIe. The common lines Busline are disposed and correspond to all of the GOA unit circuits and are configured to provide the first low frequency clock signal and the second low frequency clock signal.

Please refer to FIG. 5, the driving circuit is provided in a step S510.

Please refer to FIG. 5, in a step S520, each stage of the GOA unit circuit includes the forward-inverse scan control module, the stage voltage-stable module, the output module, the first pull down module, and the pull down holding module.

Please refer to FIG. 5, in a step S530, different delay times are provided by controlling starting times of the scan start signals of the GOA unit circuits.

Please refer to FIG. 5, in a step S540, different wave widths are provided by separately providing the odd high frequency clock signal and the even high frequency clock signal of the multiple high frequency clock signal circuit with different widths.

Please refer to FIG. 5, in a step S550, different wave heights are provided by separately providing signals with different heights to the odd high frequency clock signal and the even high frequency clock.

The driving circuit provided by the present disclosure can obtain different brightness of the main pixel and the sub-pixel according to requirements without changing the internal circuit structures of the panels. Especially after the panels are produced, the color deviation can be targeted by externally changing the circuit signal according to the color deviation situations. The adjustable range is wide.

The above-mentioned embodiments are only the preferred embodiments of the present disclosure, and are not intended to limit the present disclosure. Any modifications, equivalents, and improvements obtained within the aspect and principle of the present disclosure fall in the protected scope of the present disclosure.

### INDUSTRIAL APPLICABILITY

The subject matter of the present disclosure can be manufactured and utilized in industry with industrial applicability.

What is claimed is:

1. A driving circuit, comprising:
a plurality of gate driver on array (GOA) unit circuits, wherein odd stages of the GOA unit circuits are cascaded with each other and even stages of the GOA unit circuits are cascaded with each other;
signal lines disposed and corresponding to the odd stages of the GOA unit circuits and configured to respectively provide odd stage scan control signals, odd stage scan start signals, and odd stage high frequency clock signals;
signal lines disposed and corresponding to the even stages of the GOA unit circuits and configured to respectively provide even stage scan control signals, even stage scan start signals, and even stage high frequency clock signals; and
a common line disposed and corresponding to all of the GOA unit circuits and configured to provide a first low frequency clock signal and a second low frequency clock signal.

2. The driving circuit according to claim 1, wherein each stage of the GOA unit circuit comprises a forward-inverse scan control module, a stage voltage-stable module, an output module, a first pull down module, and a pull down holding module.

3. The driving circuit according to claim 1, further comprising a pixel circuit comprising a first switch, wherein a control end of the first switch is configured to receive a gate signal outputted from a GOA unit, a first end of the first switch is electrically connected to an electrode of a main pixel, and a second end of the first switch is configured to receive a data line signal.

4. The driving circuit according to claim 3, further comprising a second switch, wherein a control end of the second switch is configured to receive the gate signal outputted from the GOA unit, a first end of the second switch is electrically connected to an electrode of a sub pixel, and a second end of the second switch is configured to receive the data line signal.

5. The driving circuit according to claim 3, further comprising a third switch, wherein a control end of the third switch is configured to receive a gate signal outputted from a next stage of the GOA unit, a first end of the third switch is electrically connected to a storage capacitor, and a second end of the third switch is electrically connected to the electrode of the sub pixel.

6. A driving method of a driving circuit, comprising:
providing the driving circuit according to claim 1;
wherein each stage of the GOA unit circuit comprises a forward-inverse scan control module, a stage voltage-stable module, an output module, a first pull down module, and a pull down holding module;
providing different delay times by controlling starting times of the scan start signals of the GOA unit circuits;
providing different wave widths by separately providing an odd high frequency clock signal and an even high frequency clock signal of a multiple high frequency clock signal circuit with different widths; and
providing different wave heights by separately providing signals with different heights to the odd high frequency clock signal and the even high frequency clock.

7. The driving method of the driving circuit according to claim 6, further comprising a pixel circuit comprising a first switch, wherein a control end of the first switch is configured to receive a gate signal outputted from a GOA unit, a first end of the first switch is electrically connected to an electrode of a main pixel, and a second end of the first switch is configured to receive a data signal.

8. The driving method of the driving circuit according to claim 7, further comprising a second switch, wherein a control end of the second switch is configured to receive the gate signal outputted from the GOA unit, a first end of the second switch is electrically connected to an electrode of a sub pixel, and a second end of the second switch is configured to receive the data signal.

9. The driving method of the driving circuit according to claim 7, further comprising a third switch, wherein a control end of the third switch is configured to receive a gate signal outputted from a next stage of the GOA unit, a first end of the third switch is electrically connected to a storage capacitor, and a second end of the third switch is electrically connected to the electrode of the sub pixel.

10. A display panel, comprising:
a first substrate; and
a second substrate disposed opposite to the first substrate;
wherein the display panel further comprises a driving circuit comprising:
a plurality of gate driver on array (GOA) circuits, wherein odd stages of the GOA unit circuits are cascaded with each other and even stages of the GOA unit circuits are cascaded with each other;
signal lines disposed and corresponding to the odd stages of GOA unit circuits and configured to respectively provide odd stage scan control signals, odd stage scan start signals, and odd stage high frequency clock signals;
signal lines disposed and corresponding to the even stages of GOA unit circuits and configured to respectively provide even stage scan control signals, even stage scan start signals, and even stage high frequency clock signals; and
a common line disposed and corresponding to all of the GOA unit circuits and configured to provide a first low frequency clock signal and a second low frequency clock signal.
